(19) United States
(12) Patent Application Publication
(10) Pub. No.: US 2026/0342180 A1
(43) Pub. Date: Oct. 29, 2026

(54) DRIVE DEVICE

(71) Applicant: DENSO CORPORATION, Kariya-city (JP)

(72) Inventors: Shun MORISHITA, Kariya-city (JP); Tomoaki YOSHIMI, Kariya-city (JP); Naohiro YAMAMOTO, Kariya-city (JP)

(21) Appl. No.: 19/447,652

(22) Filed: Jan. 13, 2026

Related U.S. Application Data
(63) Continuation of application No. PCT/JP2024/024801, filed on Jul. 9, 2024.

(30) Foreign Application Priority Data
Jul. 18, 2023 (JP) 2023-116748

(51) Int. Cl. H02K 11/33; B62D 5/04; H02K 5/08; H02K 5/173; H02K 5/22; H02K 15/123; H02K 15/144; H02K 15/32

(52) U.S. Cl. CPC H02K 11/33; B62D 5/046; H02K 5/08; H02K 5/1732; H02K 5/225; H02K 15/123; H02K 15/144; H02K 15/32; H02K 2211/03

(57) ABSTRACT

A drive device includes an electric motor and a controller. The electric motor includes: a motor housing which includes a motor case formed in a tubular shape; a stator which is fixed to the motor housing; a plurality of motor wires which are wound around the stator; a rotor which is configured to be rotated in response to energization of the plurality of motor wires; and a shaft which is configured to be rotated integrally with the rotor. The controller includes: a circuit board on which a plurality of electronic components configured to control a drive operation of the electric motor are mounted; and a controller housing that receives the circuit board. The controller is disposed on one side of the electric motor in an axial direction of the electric motor. The controller housing seals one end portion of the motor case which faces the controller.

### CROSS REFERENCE TO RELATED APPLICATIONS

This application is a continuation application of International Patent Application No. PCT/JP2024/024801 filed on Jul. 9, 2024, which designated the U.S. and claims the benefit of priority from Japanese Patent Application No. 2023-116748 filed on Jul. 18, 2023. The entire disclosures of all of the above applications are incorporated herein by reference.

### TECHNICAL FIELD

The present disclosure relates to a drive device.

### BACKGROUND

Previously, an electric motor of an integrated electromechanical type, in which a controller is integrally formed on one axial side of the electric motor, has been proposed. For example, in the previously proposed electric motor, a cover, a frame and a motor case are bonded together by a seal material.

### SUMMARY

According to the present disclosure, there is provided a drive device that may include an electric motor and a controller. The electric motor may include: a motor housing which includes a motor case formed in a tubular shape; a stator which is fixed to the motor housing; a plurality of motor wires which are wound around the stator; a rotor which is configured to be rotated in response to energization of the plurality of motor wires; and a shaft which is configured to be rotated integrally with the rotor. The controller may include: a circuit board on which a plurality of electronic components configured to control a drive operation of the electric motor are mounted; and a controller housing that receives the circuit board. The controller may be disposed on one side of the electric motor in an axial direction of the electric motor. The controller housing may seal one end portion of the motor case which faces the controller.

### BRIEF DESCRIPTION OF DRAWINGS

The drawings described herein are for illustrative purposes only of selected embodiments and not all possible implementations, and are not intended to limit the scope of the present disclosure.

FIG. 1 is a schematic configuration diagram of a steering system according to a first embodiment.

FIG. 2 is a cross-sectional view of a drive device according to the first embodiment.

FIG. 3 is a schematic diagram illustrating a connection between a motor case and an ECU case according to the first embodiment.

FIG. 4 is a flowchart illustrating an assembly process of the drive device according to the first embodiment.

FIG. 5 is an explanatory diagram illustrating assembly of the motor case and a stator according to the first embodiment.

FIG. 6 is an explanatory diagram illustrating assembly of a rotor assembly according to the first embodiment.

FIG. 7 is an explanatory diagram illustrating assembly of a motor assembly according to the first embodiment.

FIG. 8 is an explanatory diagram illustrating assembly of an ECU case and an ECU assembly to the motor assembly according to the first embodiment.

FIG. 9 is a cross-sectional view of a drive device according to a second embodiment.

FIG. 10 is a flowchart illustrating an assembly process of the drive device according to the second embodiment.

FIG. 11 is an explanatory diagram illustrating formation of a motor case according to the second embodiment.

FIG. 12 is an explanatory diagram illustrating assembly of an ECU case to a motor assembly according to the second embodiment.

FIG. 13 is a cross-sectional view of a drive device according to a third embodiment.

FIG. 14 is a flowchart illustrating an assembly process of the drive device according to the third embodiment.

FIG. 15 is an explanatory diagram illustrating assembly of an inner case according to the third embodiment.

FIG. 16 is an explanatory diagram illustrating formation of a motor case and assembly of an ECU case to the motor case according to the third embodiment.

FIG. 17 is a cross-sectional view of a drive device according to a fourth embodiment.

### DETAILED DESCRIPTION

Previously, an electric motor of an integrated electromechanical type, in which a controller is integrally formed on one axial side of the electric motor, has been proposed. For example, in the previously proposed electric motor, a cover, a frame and a motor case are bonded together by a seal material.

For example, in the structure that prevents the ingress of water droplets into an interior of the device using the seal material or a packing member, there is a risk that the waterproof performance may be degraded if a gap is formed due to age-related deterioration or the like.

A drive device of the present disclosure includes an electric motor and a controller. The electric motor includes: a motor housing which includes a motor case formed in a tubular shape; a stator which is fixed to the motor housing; a plurality of motor wires which are wound around the stator; a rotor which is configured to be rotated in response to energization of the plurality of motor wires; and a shaft which is configured to be rotated integrally with the rotor.

The controller includes: a circuit board on which a plurality of electronic components configured to control a drive operation of the electric motor are mounted; and a controller housing that receives the circuit board. The controller is disposed on one side of the electric motor in an axial direction of the electric motor. The controller housing seals one end portion of the motor case which faces the controller. This makes it possible to limit ingress of water droplets or the like into the interior of the device.

Hereinafter, a drive device of the present disclosure will be described with reference to the drawings. In the following description, the same reference signs are given to substantially the same portions among the following embodiments, and the redundant description thereof will be omitted for the sake of simplicity.

### First Embodiment

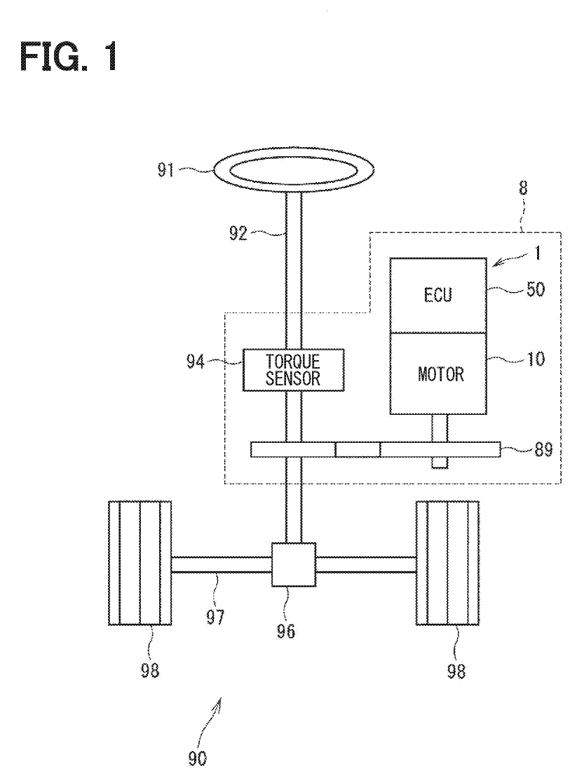

FIGS. 1-8 show the first embodiment. As shown in FIG. 1, a drive device 1 includes an electric motor 10 and an ECU (serving as a controller) 50 and is applied to an electric power steering apparatus 8. FIG. 1 shows a configuration of a steering system 90 including the electric power steering apparatus 8. The steering system 90 includes: a steering wheel 91, which serves as a steering member; a steering shaft 92; a pinion gear 96; a rack shaft 97; a plurality of wheels 98; and the electric power steering apparatus 8.

The steering wheel 91 is connected to the steering shaft 92. A torque sensor 94, which is configured to detect steering torque, is installed on the steering shaft 92. The pinion gear 96 is installed to a distal end portion of the steering shaft 92. The pinion gear 96 is meshed with the rack shaft 97. A pair of wheels 98 are coupled to two ends of the rack shaft 97 via tie rods or the like.

When a driver of the vehicle rotates the steering wheel 91, the steering shaft 92 connected to the steering wheel 91 is rotated. The rotational motion of the steering shaft 92 is converted into linear motion of the rack shaft 97 by the pinion gear 96. The pair of wheels 98 are steered at an angle corresponding to the amount of displacement of the rack shaft 97.

The electric power steering apparatus 8 includes the drive device 1 and a speed reducing gear mechanism 89. The speed reducing gear mechanism 89 is a drive force transmission device that reduces a rotational speed of rotation outputted from the electric motor 10 and transmits the rotation to the steering shaft 92. In other words, the electric power steering apparatus 8 of the present embodiment is a so-called "column-assist type," and the steering shaft 92 can be said to be a drive subject to be driven. Alternatively, a so-called “rack-assist type” may be adopted in which the rotation of the electric motor 10 is transmitted to the rack shaft 97.

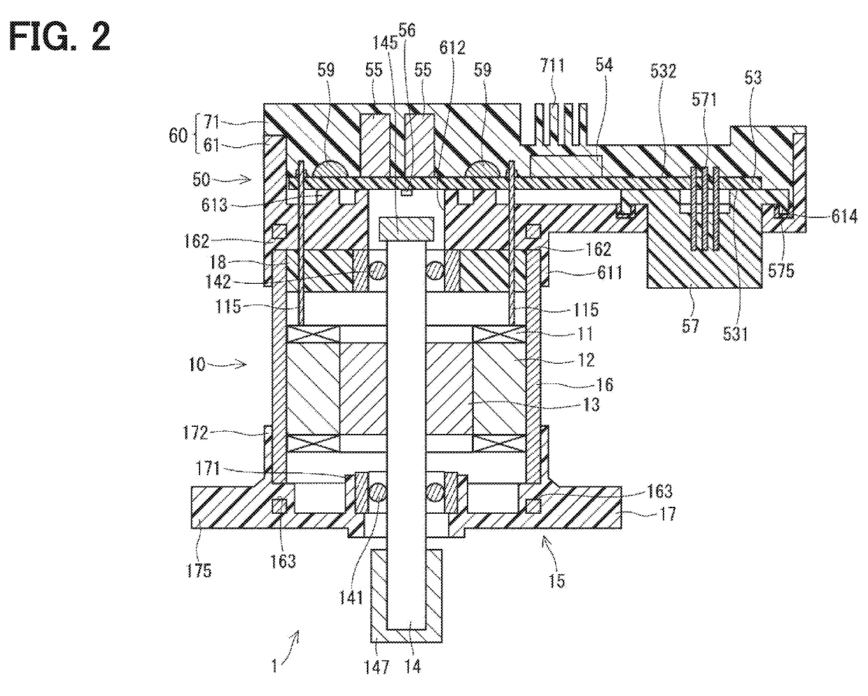

The electric motor 10 is, for example, a three-phase brushless motor. The electric motor 10 outputs a part or all of the torque required for the steering. The electric motor 10 is driven by electric power supplied from a battery (not shown) to rotate the speed reducing gear mechanism 89 in a forward or reverse direction. The drive device 1 includes the ECU 50 disposed on one side of the electric motor 10 in an axial direction of the electric motor 10 and is a so-called "integrated electromechanical type". By adopting the integrated electromechanical type, the electric motor 10 and the ECU 50 can be efficiently arranged in a vehicle with limited mounting space. Hereinafter, an axial direction and a radial direction refer to an axial direction and a radial direction of the electric motor 10. Additionally, a lower side of a sheet of FIG. 2 and the like will be referred to as an output end side.

As shown in FIG. 2, the electric motor 10 includes a stator 12, a rotor 13, a shaft 14 and a motor housing 15. The stator 12 is fixed to the motor housing 15, and a plurality of motor wires 11 are wound around the stator 12. The illustration of the motor wires 11 is omitted in drawings other than FIG. 2. The rotor 13 is disposed on the radially inner side of the stator 12 and is configured to be rotated relative to the stator 12.

The shaft 14 is fitted into the rotor 13 to rotate integrally with the rotor 13. The shaft 14 is rotatably supported by the motor housing 15 via two bearings 141, 142. One end portion of the shaft 14, which faces the ECU 50, is exposed from the motor housing 15 toward the ECU 50, and a sensor magnet 145 is installed to the one end portion of the shaft 14. The other end portion of the shaft 14, which is opposite to the ECU 50, is an output end of the shaft 14, to which a pulley 147 is installed and is coupled to the speed reducing gear mechanism 89.

The motor housing 15 includes a motor case 16, a front frame 17 and a rear frame 18. The motor case 16 is formed in a tubular shape and is made of, for example, aluminum. The front frame 17 is integrally molded with the motor case 16 on the output end side, and an ECU case 61, which will be described later, is integrally molded with the motor case 16 on the ECU 50 side. In this specification, a state, in which at least one preformed member A is insert molded and, thereby, a member B is formed, is herein referred to as “integrally molded” or “formed as an integrally molded article,” and the members A and B may be made of the same material or of different materials.

The front frame 17 is made of, for example, a phenolic resin and seals an end portion of the motor case 16 disposed on the output end side. A bearing holding portion 171, an outer-wall contact portion 172, and a plurality of flange portions 175 are formed on the front frame 17. The bearing 141 is installed in the bearing holding portion 171.

The outer-wall contact portion 172 is formed in a tubular shape along the outer peripheral wall of the motor case 16 and extends toward the ECU 50 beyond a radially inner portion of the front frame 17 which is disposed on the radially inner side of the motor case 16. The provision of the outer-wall contact portion 172 suppresses ingress of water droplets and the like into the interior of the device from the connection between the motor case 16 and the front frame 17. The flange portions 175 project radially outward and are attached to a gearbox by fastening members such as screws (not shown). The flange portions 175 may be attached to a housing other than the gearbox.

The rear frame 18 is formed in a substantially circular plate shape and is made of, for example, a phenolic resin, and the rear frame 18 is fixed to the motor case 16 on the ECU 50 side. The bearing 142 is fixed to the rear frame 18. The frames 17, 18 hold the bearings 141, 142 and may be regarded as bearing-holding members.

The ECU 50 includes a circuit board 53, a connector 57 and an ECU housing 60. The circuit board 53 extends radially outward beyond a motor region, which is a region obtained by axially projecting the motor case 16 onto the circuit board 53. The circuit board 53 is fixed to the ECU housing 60 by fastening members 59 such as tapping screws. It is also acceptable to use fastening members other than the tapping screws. For example, the circuit board 53 may be fixed to the ECU housing 60 by resin staking. Hereinafter, a surface of the circuit board 53, which faces the electric motor 10, will be referred to as a motor-side surface 531, and the other surface of the circuit board 53, which is opposite to the electric motor 10, will be referred to as a cover-side surface 532.

Lead wires 115, which extend from the motor wires 11 of respective phases, extend toward the ECU 50 and are electrically connected to the circuit board 53 within the motor region. In this embodiment, the lead wires 115 are soldered to the circuit board 53. However, as long as electrical connection is ensured, the connection method of the lead wires 115 is not limited to the soldering and may be solderless, such as a resilient connection using a press-fitting, or a mating connection using a socket connector.

Various electronic components, such as a plurality of heat-generating devices 54, a plurality of capacitors 55 and a rotational angle sensor 56, are mounted on the circuit board 53. In this embodiment, the heat-generating devices 54 and the capacitors 55 are mounted on the cover-side surface 532 of the circuit board 53. The heat-generating devices 54 include: a plurality of switching devices, which form an inverter for switching energization of the motor wires 11; a motor relay; and a power supply relay. The rotational angle sensor 56 is mounted at a corresponding location of the motor-side surface 531 opposed to the sensor magnet 145 and detects rotation of the electric motor 10 by sensing a rotating magnetic field of the sensor magnet 145. Note that, in the description of the assembly, illustration of the rotational angle sensor 56 is omitted.

The connector 57 is provided on the motor-side surface 531 of the circuit board 53 at a location outside the motor region, and connector terminals 571 are connected to the circuit board 53. A flange portion 575 is formed at an end portion of the connector 57, which faces the circuit-board 53, and the flange portion 575 extends radially outward from a main body of the connector 57. A cross-section of the flange portion 575 has an L-shape such that a distal end part of the flange portion 575 projects in a direction opposite to the circuit board 53.

The ECU housing 60 includes the ECU case 61 and an ECU cover 71. A radially outer portion of the ECU housing 60 extends to a location outside the motor region. The ECU case 61 is made of, for example, an epoxy resin and is formed in a substantially bottomed tubular shape that opens toward the side opposite to the electric motor 10. The ECU case 61 is integrally molded with the motor case 16 and seals one end portion of the motor case 16 which faces the ECU 50 in the axial direction.

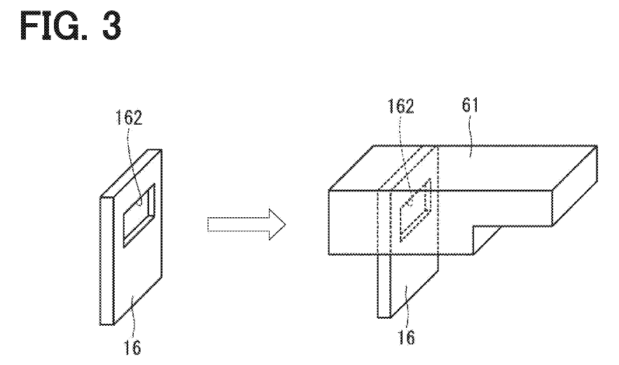

As shown in FIG. 3, the motor case 16 has a plurality of sealing holes 162 each of which extends through the motor case 16 in a plate-thickness direction of the motor case 16. The sealing holes 162 are formed at a corresponding location of the motor case 16 where the ECU case 61 is integrally molded with the motor case 16 such that the sealing holes 162 are spaced from each other and are arranged in a circumferential direction. When the motor case 16 and the ECU case 61 are integrally molded, the ECU case 61 is formed at the one end portion of the motor case 16, which faces the ECU 50, such that the ECU case 61 sandwiches a radially inner side part and a radially outer side part of the one end portion of the motor case 16. Here, the resin of the ECU case 61 penetrates into the sealing holes 162 to increase the joint strength between the ECU case 61 and the motor case 16.

Similarly, at a corresponding location of the motor case 16 where the front frame 17 is integrally molded with the motor case 16, a plurality of sealing holes 163 extend through the motor case 16 in the plate thickness direction of the motor case 16 such that the sealing holes 163 are spaced from each other and are arranged in the circumferential direction. When the motor case 16 and the front frame 17 are integrally molded, the resin of the front frame 17 penetrates into the sealing holes 163 to increase the joint strength between the front frame 17 and the motor case 16.

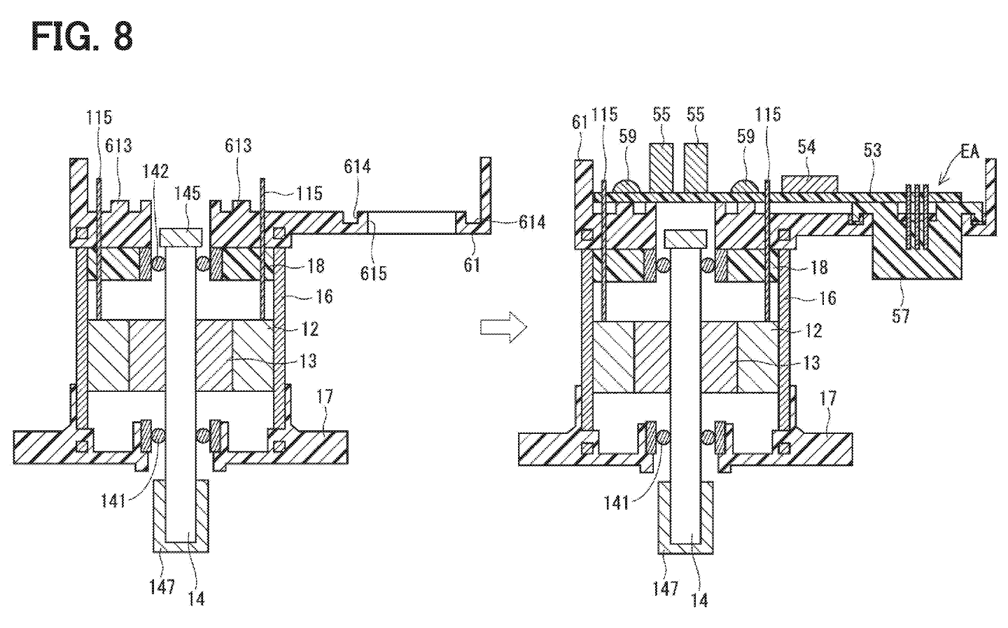

Returning to FIG. 2, the ECU case 61 has an outer-wall contact portion 611, a through-hole 612, a plurality of board holding portions 613, a connector mounting portion 614 and a connector insertion through-hole 615 (see FIG. 8).

The outer-wall contact portion 611 is formed in a tubular shape along the outer peripheral wall of the motor case 16 and extends toward the output end side beyond a radially inner portion of the ECU case 61 which is disposed on the radially inner side of the motor case 16. The outer-wall contact portion 611 suppresses ingress of water droplets and the like into the interior of the device from the connection between the motor case 16 and the ECU case 61. Note that the outer-wall contact portion 611 need not be provided, and, at the connection between the motor case 16 and the ECU case 61, the axial length of the radially outer portion of the ECU case 61, which is disposed on the radially outer side of the motor case 16, may be equal to or smaller than that of the radially inner portion of the ECU case 61. The same applies to the outer-wall contact portion 172 of the front frame 17. Furthermore, the indication of the outer-wall contact portion 611 is omitted in the drawings other than FIG. 2.

The through-hole 612 extends through the ECU case 61 in the axial direction at a location that corresponds to the shaft 14, and the sensor magnet 145 is disposed inside the through-hole 612. The board holding portions 613 are formed on the ECU case 61 within the motor region, and the circuit board 53 is fixed to the board holding portions 613 by the fastening members 59. The connector 57 is attached to the connector mounting portion 614 with an adhesive or the like. In detail, the connector 57 is attached to the ECU case 61 by inserting the flange portion 575 into the connector mounting portion 614, to which the adhesive is applied, in a state where a main body of the connector 57 is inserted through the connector insertion through-hole 615, and an opening of the connector 57 is exposed to the outside.

The ECU cover 71 is made of, for example, an epoxy resin and is installed to the cover-side surface 532 of the circuit board 53. The ECU cover 71 is integrally molded with the ECU case 61 and resin-seals the circuit board 53, as well as the heat-generating devices 54 and the capacitors 55 that are mounted on the cover-side surface 532 of the circuit board 53. The ECU cover 71 has a device-mounting region, and a plurality of heat-dissipation fins 711 are formed in this device-mounting region, which is a region defined by an axial projection of a device area of the circuit board 53 where the heat-generating devices 54 are mounted.

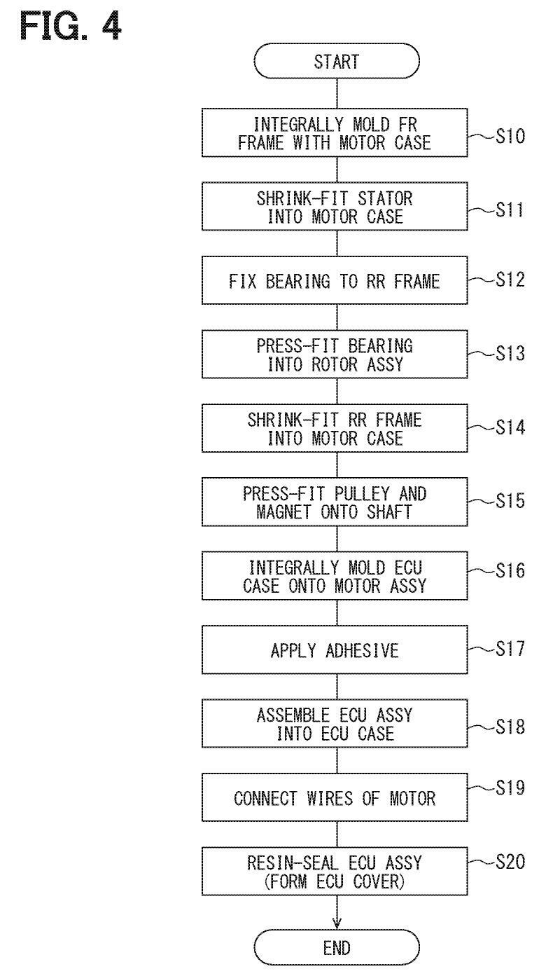

An assembly process of the drive device 1 according to this embodiment will be described with reference to a flowchart of FIGS. 4 and 5-8. Hereinafter, the term “step” in expressions such as step S10 is omitted, and only the symbol “S” is used.

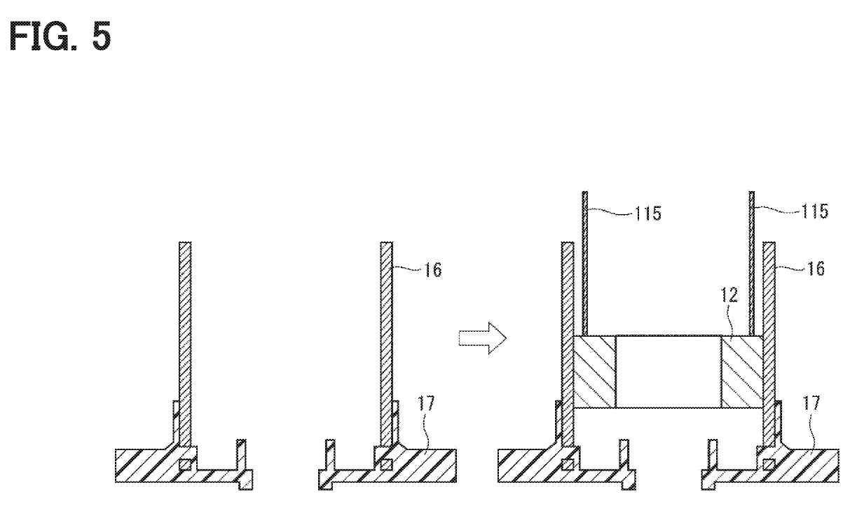

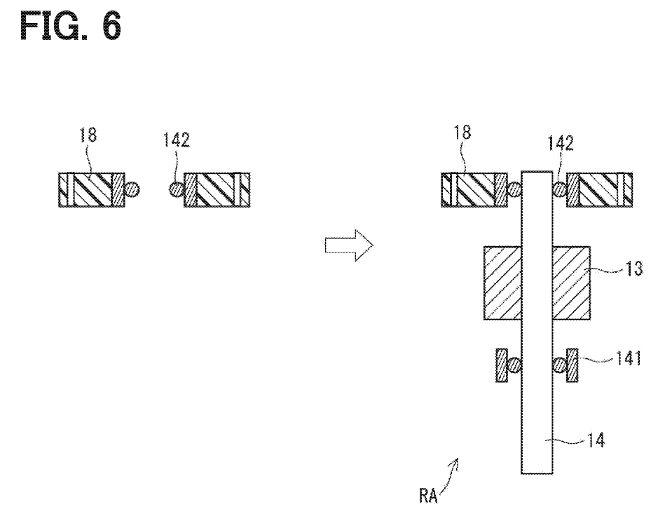

As shown in FIG. 5, in S10, the front (FR) frame 17 is integrally molded with the motor case 16. In S11, the stator 12 is shrink-fitted into the motor case 16. As shown in FIG. 6, in S12, the bearing 142 is fixed to the rear (RR) frame 18 by caulking, press-fitting, or the like. In S13, the bearings 141, 142 are press-fitted into a rotor assembly that is formed by press fitting the shaft 14 into the rotor 13. Note that S10 and S11, and S12 and S13, may be performed in a different order or in parallel.

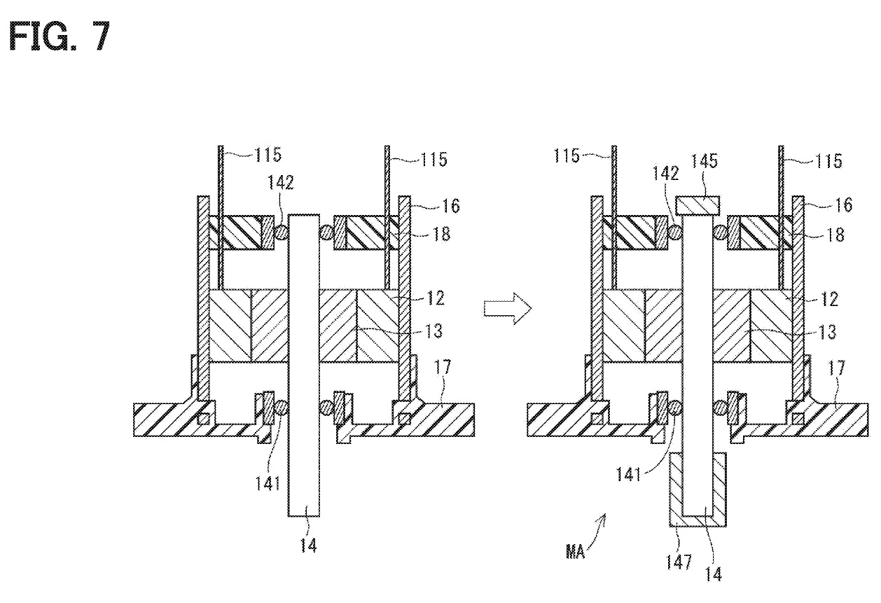

As shown in FIG. 7, in S14, the rotor assembly in a state shown on the right side of FIG. 6 is assembled to the motor case 16 in a state shown on the right side of FIG. 5. More specifically, the rear frame 18 is shrink-fitted into the motor case 16. The bearing 141 is inserted into the bearing holding portion 171 of the front frame 17. In S15, the pulley 147 is press-fitted onto the other end portion of the shaft 14, which faces the output-end side, and the sensor magnet 145 is press-fitted onto the one end portion of the shaft 14, which faces the ECU 50. Hereinafter, an assembly in a state where the stator 12, the front frame 17 and the rear frame 18 are assembled to the motor case 16 is referred to as a motor assembly.

As shown in FIG. 8, in S16, the ECU case 61 is integrally resin-molded to the motor case 16 in the state of the motor assembly (see the left side of FIG. 8). In S17, the adhesive is applied to the connector mounting portion 614 of the ECU case 61. In S18, an ECU assembly, which is in a state where the connector 57 is assembled, is assembled to the ECU case 61 (see the right side of FIG. 8).

In S19, the lead wires 115 are electrically connected to the circuit board 53. If the connection between the lead wires 115 and the circuit board 53 is a solderless connection (e.g., a press-fit connection), the connection is completed when the ECU assembly is assembled to the ECU case 61 in S18, and therefore S19 is omitted. In S20, the ECU assembly is resin-sealed to form the ECU cover 71 (see FIG. 2). In the drawings, where appropriate, “rotor assembly” is abbreviated as “RA,” “motor assembly” as “MA,” and “ECU assembly” as “EA.”

For example, as a comparative example, in a case where the rear frame is formed as a metal heat sink, and heat from the heat-generating devices 54 is dissipated toward the motor case 16, it is necessary to mount the heat-generating devices 54 on the motor-side surface 531 of the circuit board 53 within the motor region.

In contrast, in the drive device 1 of this embodiment, the heat-generating devices 54 are resin-embedded in the ECU cover 71, and the structure dissipates heat by air radiation through the ECU cover 71 that is in direct contact with the heat-generating devices 54. This enables the heat-generating devices 54 to be mounted on the cover-side surface 532 and even outside the motor region, thereby increasing the degree of freedom in circuit board design. In addition, an interposed material, such as thermal gel, which is required when dissipating heat to a metal heat sink, becomes unnecessary.

The ECU case 61 is integrally resin-molded with the motor case 16 by insert molding, and the one end portion of the motor case 16 is sealed by the ECU case 61. Additionally, the front frame 17 is integrally resin-molded with the motor case 16 by insert molding, and the other end portion of the motor case 16 is sealed by the front frame 17. This makes it possible, with a simple configuration and without any crevice-corrosion sites, to prevent the ingress of water drops, dust and the like into the interior of the device. In addition, because the connection between the ECU case 61 and the motor case 16 and the connection between the front frame 17 and the motor case 16 are sealed without using a sealing material such as an adhesive (i.e., sealant-less), no gap arises in response to aging deterioration of the sealing material, and the waterproof performance can be maintained over time. Desirably, the material of the ECU case 61 and the material of the front frame 17, which are integrally molded with the motor case 16, respectively have a coefficient of linear thermal expansion that is close to that of the material of the motor case 16.

In this embodiment, the motor case 16 is made of the metal, and the front frame 17 is made of the resin. In other words, instead of forming the motor case as a bottomed tubular shape such that the tubular portion and the portion opposite to the ECU 50 are formed as a single member, according to the present embodiment, the motor case 16 in the tubular shape and the front frame 17 in the substantially circular plate shape are separately formed. That is, the front frame 17 is formed by the resin molding at the other end portion of the motor case 16 made of the metal. Thus, the motor case 16 and the front frame 17 form the integrally molded article. This makes it possible to separate the members without degrading the corrosion resistance. Note that, by making the motor case 16 as the separate member, the front frame 17 can be formed relatively easily, making it possible to use a material that has good corrosion resistance and relatively low flowability.

As described above, the drive device 1 includes the electric motor 10 and the ECU 50. The electric motor 10 includes: the motor housing 15 which includes the motor case 16 formed in the tubular shape; the stator 12 which is fixed to the motor housing 15; the plurality of motor wires 11 which are wound around the stator 12; the rotor 13 which is configured to be rotated in response to energization of the plurality of motor wires 11; and the shaft 14 which is rotatably supported by the motor housing 15 and is configured to be rotated integrally with the rotor 13.

The ECU 50 includes: the circuit board 53 on which the plurality of electronic components configured to control the drive operation of the electric motor 10 are mounted; and the ECU housing 60 that receives the circuit board 53. The ECU 50 is disposed on the one side of the electric motor 10 in the axial direction of the electric motor 10. The electronic components include, for example, the heat-generating devices 54 and the capacitors 55. The ECU housing 60 seals the one end portion of the motor case 16 which faces the ECU 50. Specifically, the motor case 16 and the ECU case 61 are formed as the integrally molded article, and the one end portion of the motor case 16, which faces the ECU 50, is directly sealed by the ECU case 61.

This eliminates a gap between the motor case 16 and the ECU housing 60, thereby suppressing the ingress of water droplets and foreign matter into the interior of the device from the connection between the electric motor 10 and the ECU 50.

The motor housing 15 includes the front frame 17 that seals the other end portion of the motor case 16, which is opposite to the ECU 50. This makes it possible to form the front frame 17 without degrading the corrosion resistance.

The ECU housing 60 sandwiches the radially inner side part and the radially outer side part of the one end portion of the motor case 16 which faces the ECU 50. The front frame 17 sandwiches the radially inner side part and the radially outer side part of the other end portion of the motor case 16 which is opposite to the ECU 50. By sandwiching the motor case 16 from both the radially inner side and the radially outer side with the ECU case 61 or the front frame 17, which are made of the resin, the connection reliability can be improved.

At the connection between the ECU housing 60 and the motor case 16, the radially outer portion of the ECU housing 60, which is disposed on the radially outer side of the motor case 16, is longer in the axial direction than the radially inner portion of the ECU housing 60, which is disposed on the radially inner side of the motor case 16. At the connection of the front frame 17, which is connected to the motor case 16, the radially outer portion of the front frame 17, which is disposed on the radially outer side of the motor case 16, is longer in the axial direction than the radially inner portion of the front frame 17, which is disposed on the radially inner side of the motor case 16. By providing the outer-wall contact portions 172, 611 and forming the axial length of the outer-wall contact portions 172, 611 relatively longer on the radially outer side, the ingress of water droplets and the like into the interior of the device can be further suppressed.

### Second Embodiment

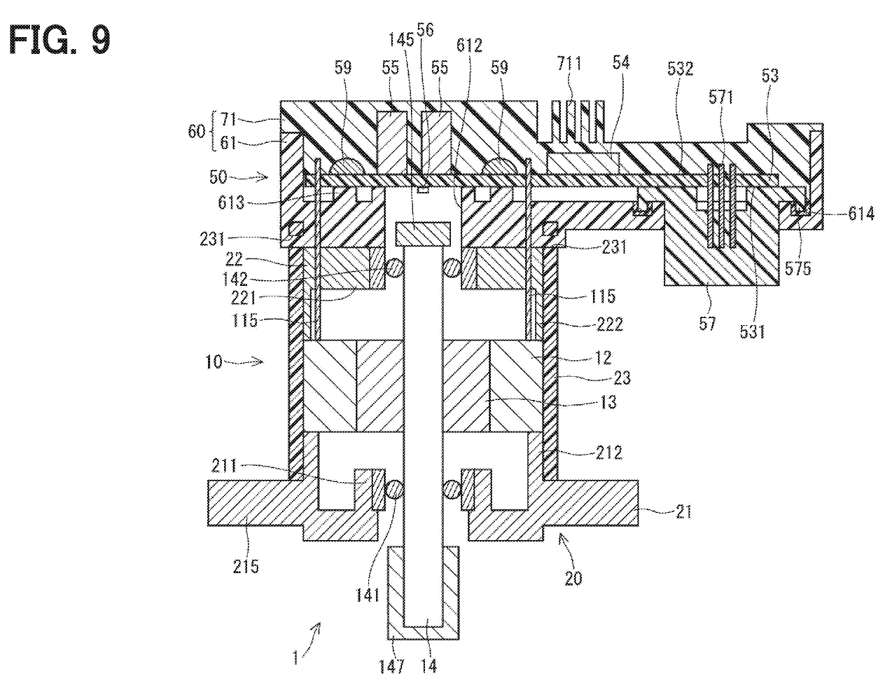

FIGS. 9-12 show the second embodiment. In the second to fourth embodiments, the motor housing mainly differs from the first embodiment. Therefore, description of the ECU 50 is omitted, and the explanation focuses on the configuration related to the motor housing.

As shown in FIG. 9, the motor housing 20 of this embodiment includes a front frame 21, a rear frame 22 and a motor case 23. The front frame 21 includes a bearing holding portion 211, a stator contact portion 212 and a plurality of flange portions 215. The front frame 21 is made of metal such as an aluminum alloy and is disposed on a side of the stator 12 which is opposite to the ECU 50.

The bearing holding portion 211 holds the bearing 141. The stator contact portion 212 is formed in a tubular shape along an inner peripheral wall of the motor case 23. The flange portions 215 project radially outward and are formed to be attached to the housing by fastening members such as screws (not shown).

The rear frame 22 includes a bearing holding portion 221 and a stator contact portion 222. The rear frame 22 is made of metal such as an aluminum alloy and is disposed on a side of the stator 12 where the ECU 50 is placed. The bearing 142 is fixed to the bearing holding portion 221 by, for example, press fitting. The stator contact portion 222 is formed in a tubular shape along the inner peripheral wall of the motor case 23.

The motor case 23 is formed in a substantially tubular shape and is made of, for example, phenolic resin. The motor case 23 is integrally molded with outer peripheral surfaces of the stator 12, the front frame 21 and the rear frame 22. A portion of the motor case 23, which is connected to the ECU case 61, has a plurality of sealing holes 231 each of which extends through the motor case 23 in a plate-thickness direction of the motor case 23. The resin of the ECU case 61 penetrates into the sealing holes 231, so that the reliability of the connection is improved.

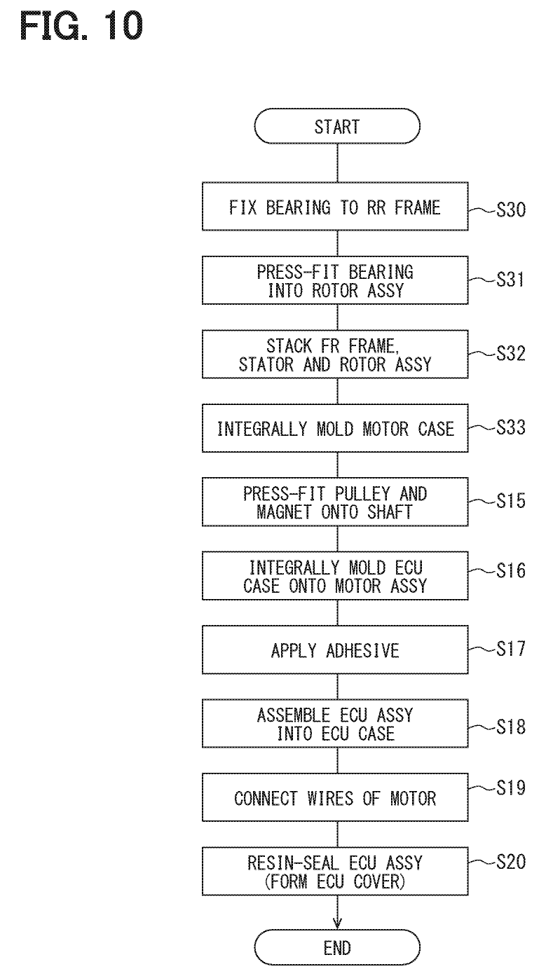

An assembly process of the motor assembly according to this embodiment will be described with reference to a flowchart of FIGS. 10 and 11 and 12. The processes of S30 and S31 are the same as the processes of S12 and S13 shown in FIG. 4, although the material and shape of the rear frame 22 differ from those of the first embodiment.

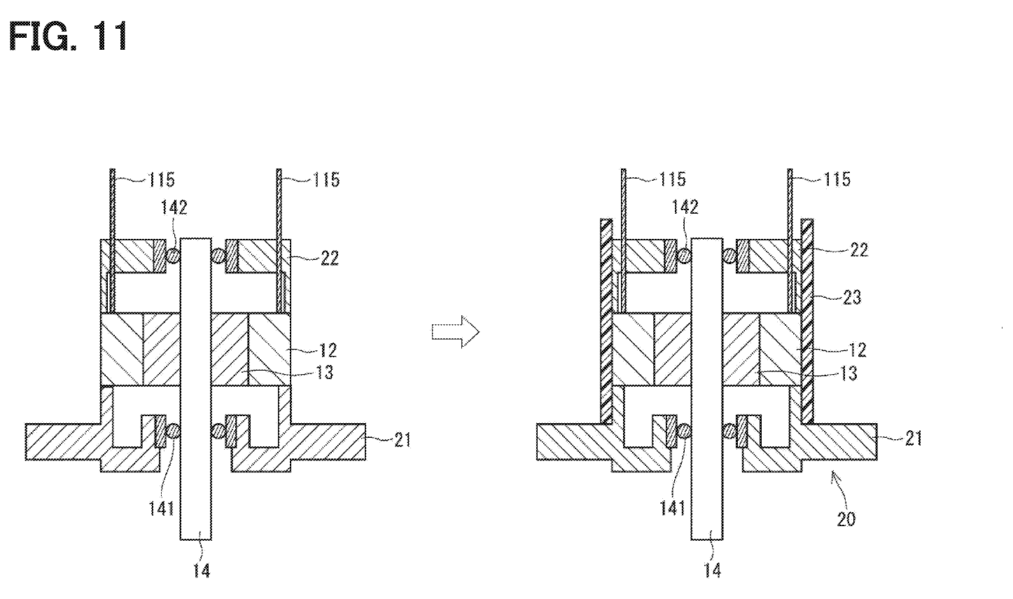

As shown in FIG. 11, in step S32, the front frame 21, the stator 12 and the rotor assembly are stacked. At this time, at an outer periphery, the front frame 21, the stator 12 and the rear frame 22 are stacked in this order from the output end side, and the stator contact portion 212 of the front frame 21 and the stator contact portion 222 of the rear frame 22 are in contact with the stator 12. Thereby, axial positions of these components are determined.

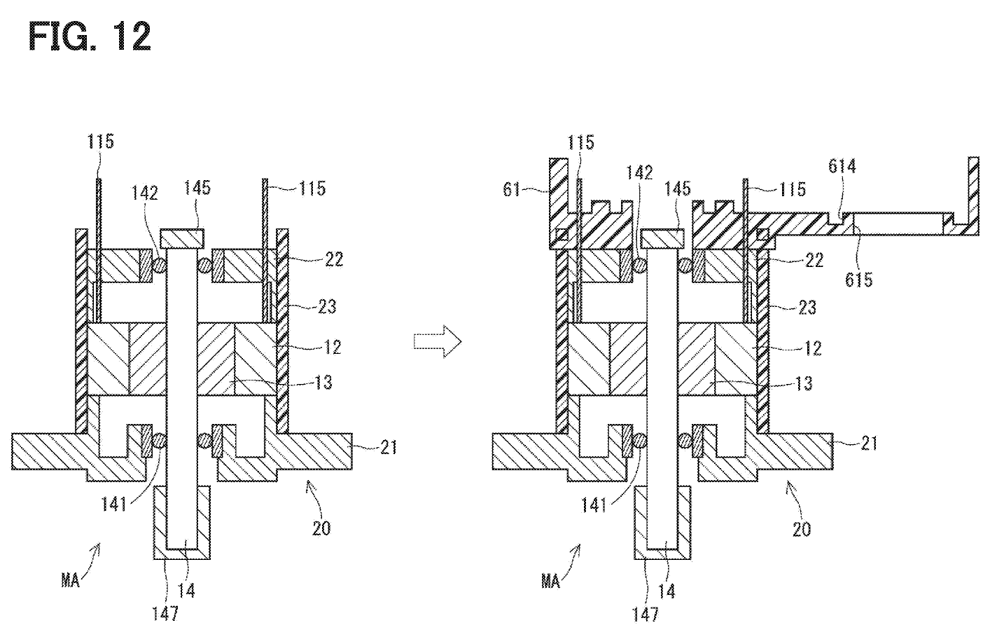

In S33, the radially outer sides of the front frame 21, the stator 12 and the rear frame 22 are encapsulated with the resin, and thereby the motor case 23 is formed. The processes from S15 onward are the same as in the first embodiment, and as shown in FIG. 12, the pulley 147 is press-fitted onto the other end portion of the shaft 14, which faces the output end side, and the sensor magnet 145 is press-fitted onto the one end portion of the shaft 14, which faces the ECU 50. Then, the ECU case 61 is integrally resin-molded onto the motor case 23. Since the assembly of the ECU 50 is the same as in the above-described embodiment, the description thereof will be omitted.

In the present embodiment, the stator 12, the front frame 21 and the rear frame 22 are integrally resin-sealed by the motor case 23. Thereby, a fixing force between the components can be increased. In addition, since the thickness required to ensure the fixing strength can be reduced, this contributes to the weight reduction of the drive device 1. In addition, by mold-joining the outer peripheral surfaces of the stator 12 and the frames 21, 22 and forming the motor case 23 by the integral molding, intrusion of water droplets or the like into the interior of the device can be limited without using a sealing material or the like.

In the present embodiment, the motor case 23 is made of the resin. Specifically, the motor housing 20 includes: the front frame 21 which is disposed on one side of the stator 12 in the axial direction; and the rear frame 22, which is disposed on the other side of the stator 12 in the axial direction. The motor case 23 is formed on the radially outer side of the front frame 21, the stator 12 and the rear frame 22 in the state where the front frame 21, the stator 12 and the rear frame 22 are stacked in the axial direction. Thereby, the front frame 21, the stator 12 and the rear frame 22 can be firmly joined by the motor case 23, so that the reliability of the connection of the members can be improved. Furthermore, the advantages similar to those described in the above embodiment can be achieved.

### Third Embodiment

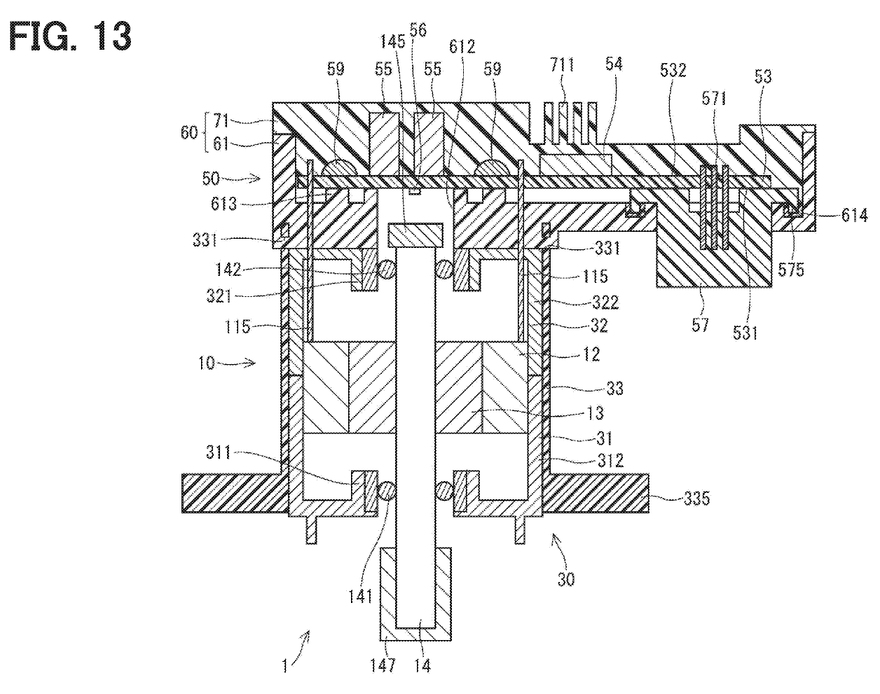

FIGS. 13-16 show the third embodiment. The motor housing 30 of the present embodiment has a front-side inner case 31, a rear-side inner case 32 and a motor case 33.

The front-side inner case 31 has a bearing holding portion 311 and a stator holding portion 312. The front-side inner case 31 is made of, for example, an aluminum alloy and is formed in a substantially bottomed tubular shape that opens toward the ECU 50. The bearing holding portion 311 holds the bearing 141. The stator holding portion 312 is formed in a tubular shape, and an end portion of the stator holding portion 312, which faces the ECU 50, is disposed between the stator 12 and the motor case 33.

The rear-side inner case 32 has a bearing holding portion 321 and a stator holding portion 322. The rear-side inner case 32 is made of, for example, an aluminum alloy and is formed in a substantially bottomed tubular shape that opens toward the side opposite to the ECU 50. The bearing 142 is fixed to the bearing holding portion 321. The stator holding portion 322 is formed in a tubular shape. An end portion of the stator holding portion 322, which is opposite to the ECU 50, is disposed between the stator 12 and the motor case 33, and contacts the front-side inner case 31 at a distal end surface thereof.

The motor case 33 is formed in a substantially tubular shape and is made of, for example, phenolic resin. The motor case 33 is integrally molded with outer peripheral surfaces of the inner cases 31, 32. A portion of the motor case 33, which is connected to the ECU case 61, has a plurality of sealing holes 331 each of which extends through the motor case 33 in a plate-thickness direction of the motor case 33. The resin of the ECU case 61 penetrates into the sealing holes 331, so that the reliability of the connection is improved. The motor case 33 has a plurality of flange portions 335 which project radially outward and are provided to install the motor case 33 to the housing by fixing members such as screws (not shown).

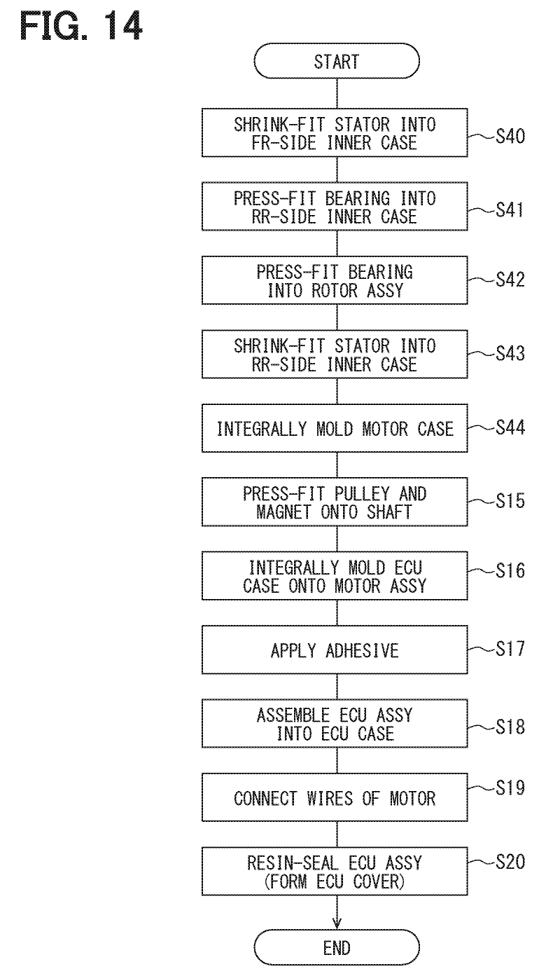

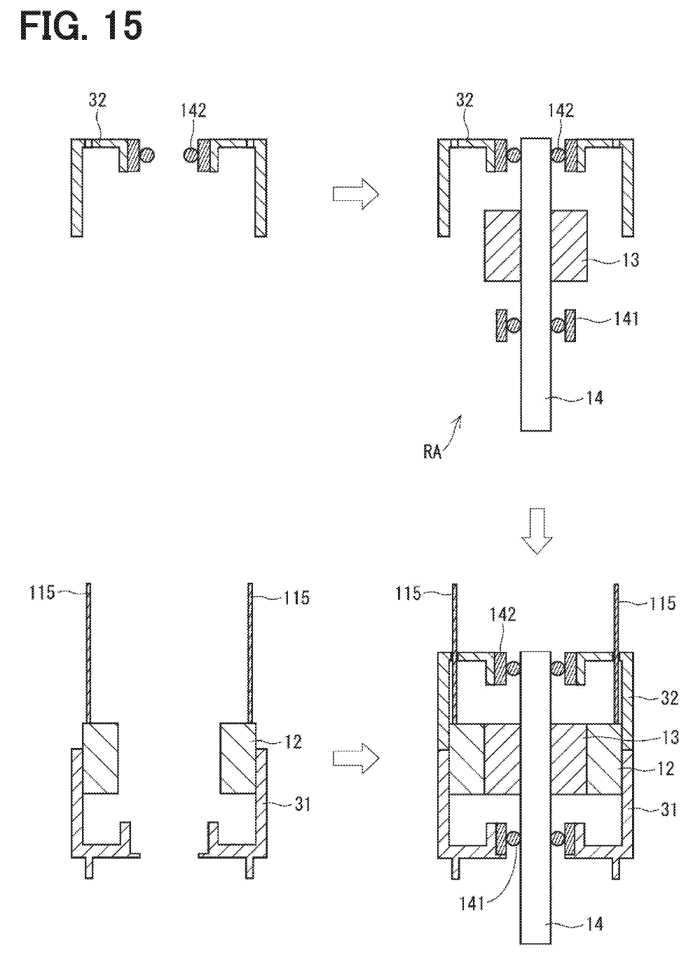

An assembly process of the motor assembly according to this embodiment will be described with reference to a flowchart of FIGS. 14 and 15 and 16. As shown in a lower left section of FIG. 15, in S40, the stator 12 is shrink-fitted to the front-side inner case 31 such that the bearing holding portion 311 is on a side opposite to a side from which the lead wires 115 of the stator 12 are taken out. Alternatively, the front-side inner case 31 and the stator 12 may be fixed together by a method other than the shrink fitting. The same applies to the fixing of the rear-side inner case 32 and the stator 12.

As shown in an upper section of FIG. 15, in S41, the bearing 142 is press-fitted into the rear-side inner case 32. In S42, the bearings 141, 142 are press-fitted onto the rotor assembly. As shown in a lower right section of FIG. 15, in S43, the rear-side inner case 32 is shrink-fitted onto the stator 12 such that the opening of the rear-side inner case 32 faces the front-side inner case 31. A contact position, at which the inner cases 31, 32 contact each other, may be any position as long as the stator 12 can be shrink-fitted to the inner cases 31, 32, and it does not matter if the contact position is displaced from a center position of the stator 12 in the axial direction.

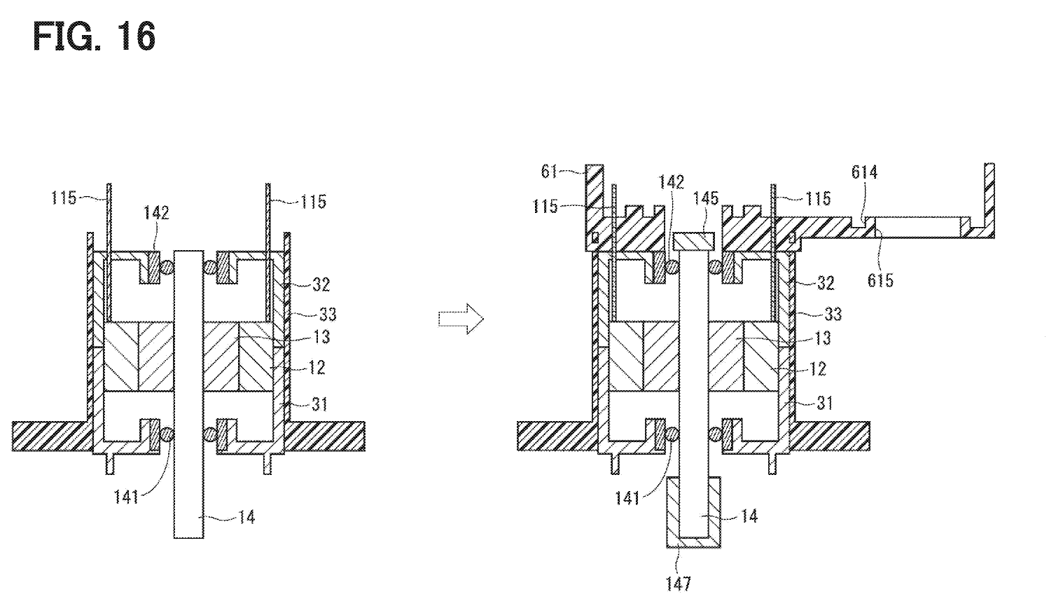

In S44, as shown in FIG. 16, the front-side inner case 31 and the rear-side inner case 32 are integrally resin-molded to form the motor case 33. The processes from S15 onward are the same as in the first embodiment, and the pulley 147 is press-fitted onto the other end portion of the shaft 14, which faces the output end side, and the sensor magnet 145 is press-fitted onto the one end portion of the shaft 14, which faces the ECU 50. Then, the ECU case 61 is integrally resin-molded onto the motor case 33. Since the assembly of the ECU side is the same as in the above-described embodiment, a description thereof will be omitted.

In the present embodiment, the stator 12 is fixed to the inner cases 31, 32, and the outer side of the inner cases 31, 32 are resin-sealed. Therefore, intrusion of water droplets or the like into the interior of the device can be limited without using a sealing material or the like. In addition, reliability against corrosion can be improved.

In the present embodiment, the motor housing 30 includes: the front-side inner case 31 which is fixed to the radially outer side part of the stator 12 and extends on the one side of the stator 12 in the axial direction; and the rear-side inner case 32 which is fixed to the radially outer side part of the stator 12 and extends on the other side of the stator 12 in the axial direction. The motor case 33 is formed on the radially outer side of the front-side inner case 31 and the rear-side inner case 32. Thereby, the motor case 33 can be formed relatively easily. Furthermore, the advantages similar to those described in the above embodiment(s) can be achieved.

### Fourth Embodiment

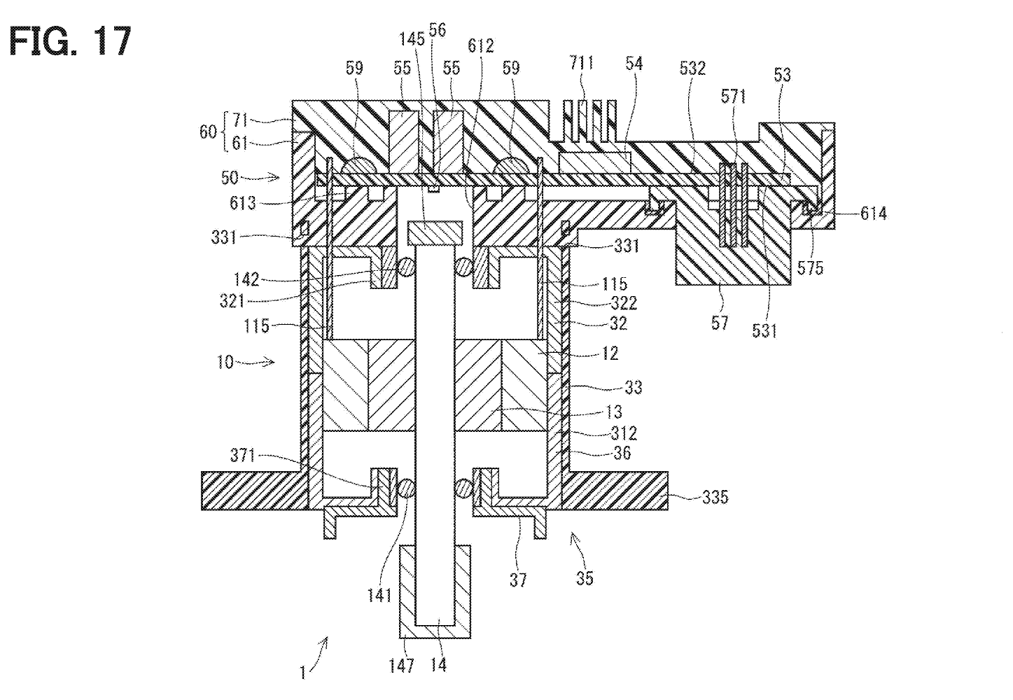

FIG. 17 shows the fourth embodiment. The motor housing 35 of the present embodiment includes a front-side inner case 36, a front frame 37, a rear-side inner case 32 and the motor case 33. In the present embodiment, the front frame 37, which has a bearing holding portion 371 for holding the bearing 141, is formed separately from the front-side inner case 36. In the assembly process, the front frame 37 is fixed to the front-side inner case 36 by shrink fitting, press fitting, or the like before the stator 12 is shrink-fitted into the front-side inner case 36. The subsequent assembly process is the same as in the third embodiment.

In the present embodiment, by forming the front frame 37 separately from the front-side inner case 36, the front-side inner case 36 can be formed by press working, and thus productivity can be improved. Furthermore, the advantages similar to those described in the above embodiment(s) can be achieved.

In the embodiments described above, the front frame 17 serves as a frame, and the front frame 21 serves as a first frame. Furthermore, the rear frame 22 serves as a second frame, and the front-side inner case 31 serves as a first inner case. Also, the rear-side inner case 32 serves as a second inner case, and the ECU 50 serves as a controller. In addition, the ECU housing 60 serves as a controller housing.

### Other Embodiments

In the embodiments described above, there is described the example, in which the phenol resin is mainly used as the material for the front frame and the rear frame, and the epoxy resin is used as the material for the controller housing. In another embodiment, the controller housing may be made of a material other than the epoxy resin. In addition, the motor housing may be made of a material other than phenol resin. For example, to further improve heat dissipation, the rear frame may be made of a metal with good thermal conductivity, such as an aluminum alloy. Further, in the first embodiment, the motor case may be made of resin. That is, there may be provided the drive device according to any one of aspects 1 to 6, wherein the motor case is made of resin.

In the embodiments described above, the motor case and the front frame are separate members, and the motor case is integrally molded with the front frame. In another embodiment, the motor case may be formed in a bottomed tubular shape that opens toward the ECU, and the motor case and the front frame may be formed as a single member. As a supplementary note, even if the motor case is formed in the bottomed tubular shape, it shall be included in the concept of a motor case formed in a tubular shape.

In the embodiments described above, the sealing holes are formed in the motor case, and the motor case and the controller housing are integrally molded in the state where the motor case is sandwiched from the radially inner side and the radially outer side. In another embodiment, when the motor case and the ECU housing are integrally molded, the sandwiching the radially inner side part and the outer side part is not required. Furthermore, the sealing holes may be eliminated. The same applies to the connection between the motor case and the front frame.

In the embodiments described above, the heat-dissipation fins (ribs) are formed in the device-mounting region onto which the device area, in which the heat-generating devices are mounted, is projected in the axial direction. In another embodiment, depending on the thermal mass of the controller housing, the heat-dissipation fins may be omitted, or a separate configuration for heat dissipation (for example, a metal plate with good thermal conductivity or a channel(s) through which a cooling fluid can flow) may be provided.

In the embodiments described above, the connector is provided on the motor-side surface of the circuit board, and the opening of the connector faces the output end side in the axial direction. In another embodiment, the connector may be provided on the cover-side surface of the circuit board, and the direction of the opening may be different from that of the embodiments described above. Furthermore, a plurality of connectors may be provided instead of the one connector. Furthermore, the device area of the circuit board, in which the devices are mounted, may be different from that of the embodiments described above. Also, provided that the heat dissipation of the electronic components can be ensured, the electronic components do not have to be embedded in the controller housing.

In the embodiments described above, the controller is formed to extend radially outward beyond the motor region. In another embodiment, the controller may be provided within the motor region. In the embodiments described above, the drive device is applied to the electric power steering apparatus. In another embodiment, the drive device may be applied to in-vehicle apparatuses other than the electric power steering apparatus, or to apparatuses other than those used in the vehicle.

The present disclosure is not limited to the embodiments described above and can be implemented in various forms without departing from the spirit of the present disclosure.

The present disclosure has been described with reference to the embodiments. However, the present disclosure is not limited to the above embodiments and the structures described therein. The present disclosure also includes various variations and variations within the equivalent range. Also, various combinations and forms, as well as other combinations and forms that include only one element, more, or less, are within the scope and ideology of the present disclosure.

What is claimed is:

1. A drive device comprising:
an electric motor that includes:
a motor housing which includes a motor case formed in a tubular shape;
a stator which is fixed to the motor housing;
a plurality of motor wires which are wound around the stator;
a rotor which is configured to be rotated in response to energization of the plurality of motor wires; and
a shaft which is configured to be rotated integrally with the rotor; and
a controller that includes:
a circuit board on which a plurality of electronic components configured to control a drive operation of the electric motor are mounted; and
a controller housing that receives the circuit board, wherein:
the controller is disposed on one side of the electric motor in an axial direction of the electric motor; and
the controller housing seals one end portion of the motor case which faces the controller.

2. The drive device according to claim 1, wherein the controller housing sandwiches a radially inner side part and a radially outer side part of the one end portion of the motor case which faces the controller.

3. The drive device according to claim 2, wherein at a connection between the controller housing and the motor case, a radially outer portion of the controller housing, which is disposed on a radially outer side of the motor case, is longer in the axial direction than a radially inner portion of the controller housing, which is disposed on a radially inner side of the motor case.

4. The drive device according to claim 1, wherein the motor housing includes a frame that seals another end portion of the motor case which is opposite to the controller.

5. The drive device according to claim 4, wherein the frame sandwiches a radially inner side part and a radially outer side part of the another end portion of the motor case which is opposite to the controller.

6. The drive device according to claim 5, wherein, at a connection between the frame and the motor case, a radially outer portion of the frame, which is disposed on a radially outer side of the motor case, is longer in the axial direction than a radially inner portion of the frame, which is disposed on a radially inner side of the motor case.

7. The drive device according to claim 1, wherein the motor case is made of resin.

8. The drive device according to claim 7, wherein:
the motor housing includes:
a first frame which is disposed on one side of the stator in the axial direction; and
a second frame which is disposed on another side of the stator in the axial direction; and
the motor case is disposed on a radially outer side of the first frame, the stator and the second frame which are stacked one after another.

9. The drive device according to claim 7, wherein:
the motor housing includes:
a first inner case which is fixed to a radially outer side part of the stator and extends on one side of the stator in the axial direction; and
a second inner case which is fixed to the radially outer side part of the stator and extends on another side of the stator in the axial direction; and
the motor case is formed on a radially outer side of the first inner case and the second inner case.
